(19) United States
(12) Patent Application Publication
(10) Pub. No.: US 2024/0321531 A1
(43) Pub. Date: Sep. 26, 2024

(54) Switch Waterproof Structure

(71) Applicants: KUAN-CHUN FANG, Tainan (TW); SHUO-I FANG, Tainan (TW)

(72) Inventors: KUAN-CHUN FANG, Tainan (TW); SHUO-I FANG, Tainan (TW)

(73) Assignees: KUAN-CHUN FANG, Tainan (TW); SHUO-I FANG, Tainan (TW)

(21) Appl. No.: 18/188,430

(22) Filed: Mar. 22, 2023

(51) Int. Cl. H01H 13/06

(52) U.S. Cl. CPC H01H 13/06

(57) ABSTRACT

The present invention provides a switch waterproof structure, which mainly includes a body, a plugger, a lever, a pin and a waterproof material. The body, the plugger and the pin each have several grooves respectively arranged thereon, and several supporting parts are each arranged between the grooves. The plugger is assembled and arranged in the body. The lever is assembled and arranged on the plugger. The pin is assembled and arranged on the body. The waterproof material after hot-melting is injected into the body, the plugger and the pin. The corresponding blocking portions can be formed after the waterproof material is flowing into the grooves of the body, the grooves of the plugger and the grooves of the pin. The blocking portions are tightly bonded to the supporting parts layer by layer, so that the waterproof material has a tight waterproof function.

### BACKGROUND OF THE PRESENT INVENTION

### Field of Invention

The present invention relates to a switch waterproof structure, in particular to the blocking portions are formed after a waterproof material is injected into the grooves of the body, the grooves of the plugger and the grooves of the pin, wherein the blocking portions are closely attached to the supporting parts of the body, the supporting parts of the plugger and the supporting parts of the pin, so as to achieve the best waterproof function and prolong the service life of the switch, and the plugger is easy to position, which can save manufacturing time.

### Description of Related Arts

It is noted that a general switch 1 (such as a toggle switch), as shown in FIG. 1, mainly includes a body 10, which has a injected part 100 and an inclined surface 101 respectively arranged on a top thereof. The body 10 has a injected hole 102 arranged in the middle thereof, and a threaded portion 103 arranged on a bottom thereof. The threaded portion 103 has pin hole 104 correspondingly arranged on two sides thereof. A pin 11 is fixed in the pin hole 104. The pin 11 extends through a perforation 120 of a plugger 12. The plugger 12 has a connecting end 121 arranged above thereof, and a tip 122 arranged on a bottom thereof. An embossing pattern 123 is provided between the tip 122 and the perforation 120. The plugger 12 is integrally formed. When a hot-melt waterproof material 13 is injected, the waterproof material 13 will cover the injected part 100, the inclined surface 101, the inner wall of the injected hole 102, the outer wall of the plugger 12 and the pin 11 to form a waterproof effect of a membrane. However, the injected part 100, the inclined surface 101, the inner wall of the injected hole 102, the outer wall of the plugger 12 and the pin 11 are not provided with grooves to support the waterproof material 13, so when the switch 1 is in use, the waterproof material 13 is likely to peel off to form a gap, resulting in water leakage and damage. In addition, the plugger 12 is integrally formed, when injecting the hot-melt waterproof material 13, it will be difficult to locate the tip 122 of the plugger 12, which will prolong the manufacturing time and be quite inconvenient.

### SUMMARY OF THE PRESENT INVENTION

A main object of the present invention is to provide a switch waterproof structure, which can effectively solve the drawbacks of conventional switches in waterproof use.

A switch waterproof structure according to the present invention comprises a injected part, a inclined surface, and a injected hole of the body, each having several first grooves arranged thereon, and several first supporting parts are each arranged between the first grooves, wherein the plugger has several second grooves arranged thereon, and several second supporting parts are each arranged between the second grooves, wherein the pin has several third grooves arranged thereon, and several third supporting parts are each arranged between the third grooves, wherein several first blocking portions, several second blocking portions and several third blocking portions are formed after the waterproof material is injected into the first grooves, the second grooves and the third grooves, wherein the blocking portions are closely attached to the supporting parts.

The switch waterproof structure according to the present invention, wherein the plugger has a positioning end arranged on a lower thereof, wherein a lever is assembled and arranged on the positioning end, wherein the lever has a rod slot arranged on a top thereof, and a tip arranged at a bottom thereof.

The switch waterproof structure according to the present invention, wherein the waterproof material is implemented as silicone rubber.

Advantages and effects of the switch waterproof structure provided by the present invention include the following: the first blocking portions, the second blocking portions and the third blocking portions are formed after the waterproof material is injected into the first grooves of the body, the second grooves of the plugger and the third grooves of the pin, wherein the first blocking portions, the second blocking portions and the third blocking portions are closely attached to the first supporting parts of the body, the second supporting parts of the plugger and the third supporting parts of the pin, so that the waterproof material can be completely sealed with the grooves and has the best waterproof function, thus extending the service life of the switch, wherein the plugger is easy to position and can save manufacturing time.

### BRIEF DESCRIPTION OF THE DRAWINGS

FIG. 1 is a sectional view of a switch according to PRIOR ART.

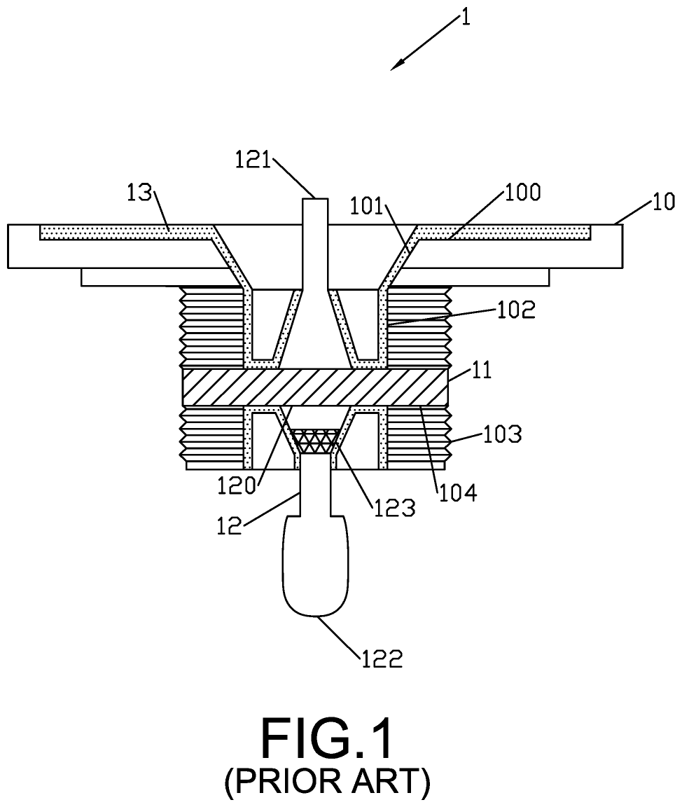

FIG. 2 is an exploded view of an embodiment of the present invention.

FIG. 3 is a perspective view of the above embodiment of the present invention.

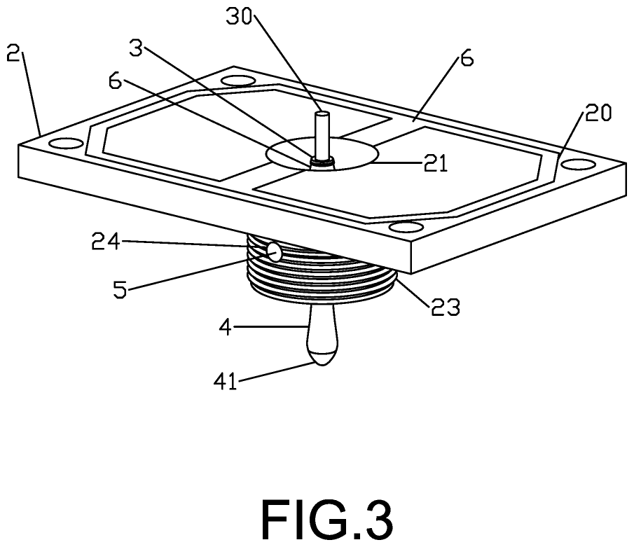

FIG. 4 is a sectional view of the above embodiment of the present invention.

FIG. 5 is a perspective view of the finished product of the above embodiment of the present invention.

### DETAILED DESCRIPTION OF THE PREFERRED EMBODIMENT

In order to achieve the above-mentioned objects and effects of the present invention, the technical means adopted are hereby enumerated through a preferred feasible embodiment, and illustrated in the drawings, detailed as follows:

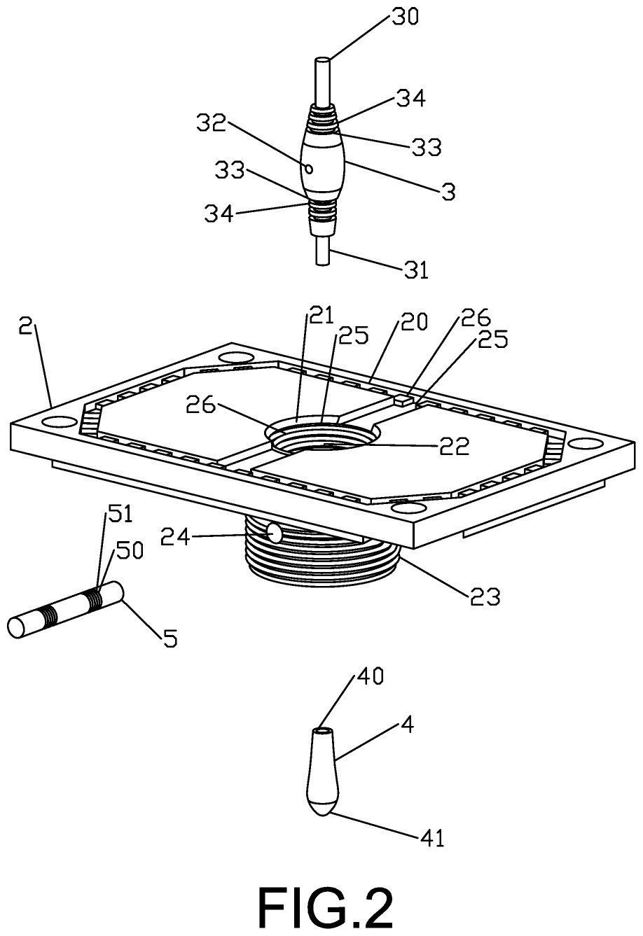

According to the embodiment of the present invention, referring to FIGS. 2˜4, is mainly composed of a body 2, a plugger 3, a lever 4, a pin 5, and a waterproof material 6, wherein the body 2 has a injected part 20 and an inclined surface 21 respectively arranged on an upper thereof, a injected hole 22 arranged in a middle thereof, a threaded portion 23 arranged at a lower thereof, and a pin hole 24 corresponds to two sides of the threaded portion 23, wherein the injected part 20, the inclined surface 21, and the injected hole 22 each have several first grooves 25 arranged thereon, and several first supporting parts 26 are each arranged between the first grooves 25, wherein the plugger 3 is assembled and arranged in the injected hole 22 of the body 2, wherein the plugger 3 has a connecting end 30 arranged on an upper thereof, a positioning end 31 arranged on a lower thereof, and a perforation 32 arranged in a middle thereof, wherein several second grooves 33 are respectively arranged between the perforation 32 and the connecting end 30, and between the perforation 32 and the positioning end 31, and a plurality of second supporting parts 34 are each arranged between the second grooves 33, wherein the lever 4 is assembled and arranged on the positioning end 31 of the plugger 3, wherein the lever 4 has a rod slot 40 arranged on a top thereof, and a tip 41 arranged at a bottom thereof, wherein the pin 5 is assembled and arranged in the pin hole 24 of the body 2, wherein the pin 5 has several second grooves 50 arranged near two ends thereof, and a plurality of third supporting parts 51 are each provided between the third grooves 50, wherein when the waterproof material 6 is injected into the body 2, the plugger 3, and the pin 5 by hot-melting, so that the waterproof material 6 covers the injected part 20, the inclined surface 21, the injected hole 22, the pin hole 24 and the perforation 32, wherein the waterproof material 6 is implemented as silicone rubber, wherein a plurality of first blocking portions 60 are formed after the waterproof material 6 is injected into the first grooves 25 of the body 2, and the first blocking portions 60 are tightly bonded to the first supporting parts 26 layer by layer, wherein a plurality of second blocking portions 61 are formed after the waterproof material 6 is injected into the second grooves 33 of the plugger 3, and the second blocking portions 61 are tightly bonded to the second supporting parts 34 layer by layer, wherein a plurality of third blocking portions 62 are formed after the waterproof material 6 is injected into the third grooves 50 of the pin 5, and the third blocking portions 62 are closely bonded to the third supporting parts 51 layer by layer. In this way, it is a switch waterproof structure.

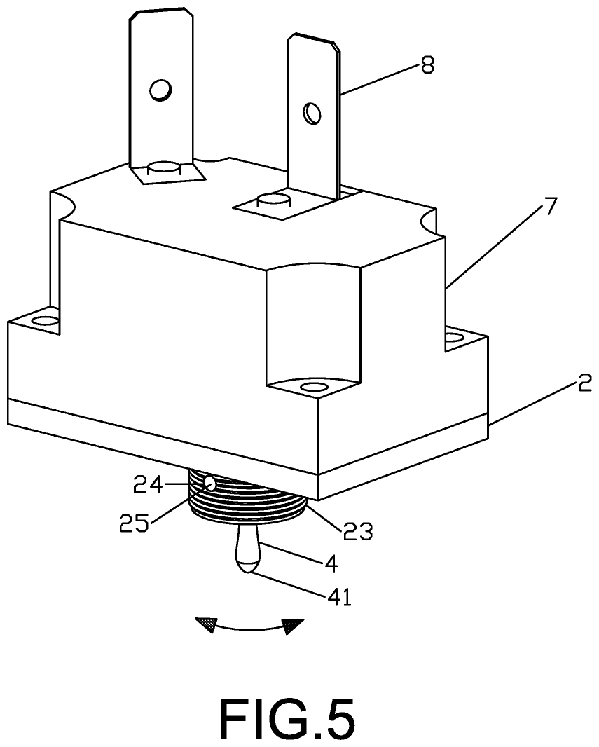

When assembling and injecting, referring to FIGS. 2˜4, first, assembling the plugger 3 in the injected hole 22 of the body 2, wherein the perforation 32 of the plugger 3 corresponds with the pin hole 24 of the body 2, then assembling and arranging the pin 5 in the pin hole 24 of the body 2 and the perforation 32 of the plugger 3, positioning the body 2 and the positioning end 31 of the plugger 3, hot-melt injecting the waterproof material 6 on the body 2, the plugger 3 and the pin 5, covering the injected part 20, the inclined surface 21, the injected hole 22, the pin hole 24 and the perforation 32 by the waterproof material 6, forming first blocking portions 60 after the waterproof material 6 is injected into the first grooves 25 of the body 2, closely fitting the first blocking portions 60 and the first supporting parts 26 layer by layer, forming second blocking portions 61 after the waterproof material 6 is injected into the second grooves 33 of the plugger 3, closely fitting the second blocking portions 61 and the second supporting parts 34 layer by layer, forming third blocking portions 62 after the waterproof material 6 is injected into the third grooves 50 of the pin 5, closely fitting the third blocking portions 62 and the third supporting parts 51 layer by layer, finally, assembling the rod slot 40 of the lever 4 on the positioning end 31 of the plugger 3 to complete the overall assembly. In addition, a shell 7 and plugs 8 of different specifications are installed on the body 2 according to user requirements (as shown in FIG. 5). The shell 7 and the plugs 8 are known technologies, so they will not be described again.

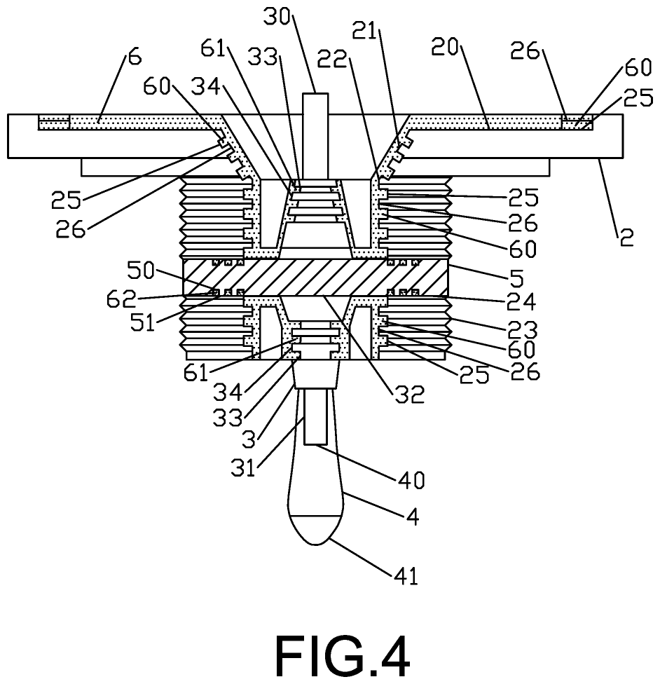

When using, referring to FIGS. 4 and 5, the tip 41 of the lever 4 is used for opening or closing of the switch, under long-term operation, by the first blocking portions 60 are formed after the waterproof material 6 is injected into the first grooves 25 of the body 2, and the first blocking portions 60 are tightly bonded with the first supporting parts 26 layer by layer, the second blocking portions 61 are formed after the waterproof material 6 is injected into the second grooves 33 of the plugger 3, and the second blocking portions 61 are tightly bonded with the second supporting parts 34 layer by layer, and the third blocking portions 62 are formed after the waterproof material 6 is injected into the third grooves 50 of the pin 5, and the third blocking portions 62 are tightly bonded with the third supporting parts 51 layer by layer, so that the waterproof material 6 has a tight waterproof function to prolong the service life of the switch, and the positioning end 31 of the plugger 3 is easy to position, and it is convenient to inject the waterproof material 6, which can save manufacturing hours.

In summary, the present invention has indeed achieved the expected objects and effects, and is more ideal and practical than those in the art. The above-mentioned embodiment is only specific descriptions for the preferred embodiments of the present invention, the embodiment is not intended to limit the scope of the patent application of the present invention, and all other equivalent changes and modifications accomplished without departing from the technical means disclosed in the present invention shall be covered by the present application.

What is claimed is:

1. A switch waterproof structure, consisting essentially of a body, a plugger, a pin and a waterproof material, wherein the body has a injected part and an inclined surface respectively arranged on an upper thereof, a injected hole arranged in a middle thereof, a threaded portion arranged at a lower thereof, and a pin hole corresponds to two sides of the threaded portion, wherein the plugger is assembled and arranged in the injected hole of the body, wherein the plugger has a connecting end arranged on an upper thereof, and a perforation arranged in a middle thereof, wherein the pin is assembled and arranged in the pin hole of the body, wherein the waterproof material is injected into the body, the plugger and the pin by hot-melting, so that the waterproof material covers the injected part, the inclined surface, the injected hole, the pin hole and the perforation, characterized in that:
the injected part, the inclined surface, and the injected hole of the body each having several first grooves arranged thereon, and several first supporting parts are each arranged between the first grooves, wherein the plugger has several second grooves arranged thereon, and several second supporting parts are each arranged between the second grooves, wherein the pin has several third grooves arranged thereon, and several third supporting parts are each arranged between the third grooves, wherein several first blocking portions, second blocking portions, and third blocking portions are formed after the waterproof material is injected into the first grooves, the second grooves, and the third grooves, wherein the blocking portions are tightly bonded with the supporting parts layer by layer.

2. The switch waterproof structure, as recited in claim 1, wherein the plugger has a positioning end arranged on a lower thereof, wherein a lever is assembled and arranged on the positioning end, wherein the lever has a rod slot arranged on a top thereof, and a tip arranged at a bottom thereof.

3. The switch waterproof structure, as recited in claim 1, wherein the waterproof material is implemented as silicone rubber.
